(19) United States
(12) Patent Application Publication
(10) Pub. No.: US 2013/0048018 A1
(43) Pub. Date: Feb. 28, 2013

(54) POST-CMP CLEANING BRUSH

(71) Applicants: Christopher Wargo, Wellesley, MA (US); Rakesh Kumar Singh, Acton, MA (US); David Trio, Dracut, MA (US); Eric McNamara, Nashua, NH (US)

(72) Inventors: Christopher Wargo, Wellesley, MA (US); Rakesh Kumar Singh, Acton, MA (US); David Trio, Dracut, MA (US); Eric McNamara, Nashua, NH (US)

(73) Assignee: ENTEGRIS, INC., Billerica, MA (US)

(21) Appl. No.: 13/580,423

(22) PCT Filed: Feb. 21, 2011
(86) PCT No.: PCT/US2011/025623

§ 371 Date: Oct. 26, 2012

(30) Foreign Application Priority Data
Feb. 22, 2010 (US) 61306582
Dec. 21, 2010 (US) 61425644

(51) Int. Cl. B08B 1/04

(52) U.S. Cl. 134/6; 15/88.4; 15/97.1

(57) ABSTRACT

Embodiments of the invention include a CMP brush that has a combination of central nodules at an inner region of the brush and one or more edge nodules at an end region of the brush where the central nodules and edge nodules are in a staggered or matched arrangement with each other and an upper surface of each edge nodule on the brush has the same or a greater contact area than an upper surface of a central nodule. The area of contact of the upper surface of each edge nodule with the substrate edge region is the same or greater than the area of contact of the upper surface of a central nodule with the substrate center region.

### PRIORITY CLAIM

The present Application claims the benefit of U.S. Provisional Application Nos. 61/425,644, filed Dec. 21, 2010, and 61/306,582, filed Feb. 22, 2010 which are fully incorporated herein by reference.

### FIELD OF THE INVENTION

The present invention is generally directed to chemical mechanical polishing of substrates. More specifically, the present invention is directed to a brush for cleaning substrates following chemical mechanical polishing.

### BACKGROUND OF THE INVENTION

Integrated circuits can be formed on semiconductor substrates, particularly silicon wafers, by the sequential deposition of conductive, semiconductive and insulative layers on the wafer. Circuitry features can be etched on after each layer is deposited. After a series of layers have been deposited and etched, the uppermost surface of the substrate can become increasingly non-planar. Non-planar surfaces can cause problems in the photolithographic steps of the integrated circuit fabrication process. As such, it is necessary to periodically planarize the semiconductor substrate surface.

Damascene is a process in which interconnecting metal lines are formed by isolating dielectrics. In damascening, an interconnecting pattern is first lithographically defined in the layer of dielectric, and then metal is deposited to fill in the resulting trenches. Excess metal can be removed by chemical-mechanical polishing (planarization). Chemical-mechanical polishing (CMP), also called chemical-mechanical planarization, refers to a method of removing layers of solid through chemical-mechanical polishing carried out for the purpose of surface planarization and definition of the metal interconnecting pattern. Dual damascene is a modified version of the damascene process that is used to form metal interconnecting geometry using a CMP process instead of metal etching. In dual damascene, two interlayer dielectric patterning steps and one CMP step create a pattern that would otherwise require two patterning steps and two metal CMP steps when using a conventional damascene process.

In a typical CMP operation, a rotating polishing pad, which receives a chemically reactive slurry, is used to polish the outermost surface of the substrate. The substrate is positioned over the polishing pad and is held in place by a retaining ring. Typically the substrate and retaining ring are mounted on a carrier or polishing head. A controlled force is exerted on the substrate by the carrier head to press the substrate against the polishing pad. The movement of the polishing pad across the surface of the substrate causes material to be chemically and mechanically removed from the face of the substrate.

After polishing, slurry residue conventionally is cleaned or scrubbed from wafer surface via a scrubbing device such as a brush. U.S. Pat. No. 4,566,911 discloses a cleaning brush roller with a gear-like configuration having many parallel grooves formed at an angle to the roll axis of 0 degrees to 90 degrees and also discloses projections of a circular, ellipsoidal, rectangular, or diamond shape or the like and having a total surface area of the projections of 15% to 65% of the whole surface area.

U.S. Pat. No. 6,299,698 discloses a wafer edge scrubber brush for simultaneously scrubbing both planar and profiled (e.g., edge) surfaces of a thin disk such as a semiconductor wafer. The brush has a contact surface having two portions, a planar portion for contacting a planar surface of a wafer, and a profiled portion for contacting an edge surface of a wafer. According to the disclosure, the profiled nodules are preferably elongated and extend to the end of the brush, the profiled nodules (in the cross-section and/or longitudinal directions) have a profile which corresponds to the edge region of a wafer to be cleaned by the brush. The profiled portion of the brush for contacting a wafer along a profiled plane has a profiled surface prior to contacting the wafer. The profiled nodules also may have a higher modulus of elasticity than that of the planar nodules.

However, using conventional chemical mechanical polishing brushes, an undesirable number of particles can still remain on scrubbed substrate surfaces, especially in the near edge region. Accordingly, a continuing need exists for improved methods and brushes that produce uniform cleaning across substrates like semiconductor wafers in the central region as well as the edge regions.

### SUMMARY OF THE INVENTION

The present invention is a post-CMP cleaning brush that can be used to clean various substrates such as semiconductor wafers, hard disks, flat panels and the like. The post-CMP brush has a combination of central nodules at an inner region of the brush and one or more edge nodules at or near end regions of the brush. The central nodules and edge nodules can be in a staggered or matched arrangement with each other and an upper surface of each edge nodule on the brush has the same or a greater contact area than an upper surface of a central nodule. The area of contact of the upper surface of each edge nodule with a substrate edge region is the same or greater than the area of contact of the upper surface of a central nodule with a substrate center region. The heights of the tops of the central nodules and heights of the tops of the edge nodules are substantially the same, or are the same within about ±5%, or less, of a mean height for the nodules as measured for example from an axis of rotation of the brush. The nodules at the near end region of the brush lack a profile of the substrate.

A post CMP cleaning brush according to an embodiment of the present invention includes a cylindrical foam brush with a first end and a second end, the brush has an outer surface and a plurality central nodules and a plurality of edge nodules on a surface of the brush. The central nodules are located in a center region of the brush and the central nodules are separated from each other by gaps. The edge nodules are located near the first end and near the second end of the brush and the edge nodules and are separated from the central nodules by gaps. The central nodules and edge nodules are arranged on the surface of the brush such that no straight line channel running annularly around the brush is formed by central nodules or edge nodules. The central nodules have a top surface and a central nodule top surface height measured from a rotational axis of the brush to the central nodule top surface. The edge nodules have a top surface and a edge nodule top surface height measured from the rotational axis of the brush to the edge nodule top surface. The central nodule top surface height and the edge nodule top surface height are the same or differ by an amount less than an edge profile portion of the substrate. The area of a top surface of an edge nodule is greater than the area of a top surface of a central nodule and the area of the top surface of an edge nodule is less than the area encompassed by four, or fewer, central protrusions.

In some embodiments of the invention the arrangement of central nodules and edge nodules results in a brush where the friction between the brush and a substrate is within about ±10%, or less, of the friction between the substrate and a brush that only has central protrusions.

Another embodiment of the invention is a method of post CMP cleaning of a surface of a semiconductor wafer. The method includes engaging the surface of a rotating wafer with a rotating cylindrical foam roller, the cylindrical foam roller having a circumferentially extending row of elongate nodules extending around the cylindrical foam roller. Each of the nodules can have a side surface and an outer wafer engagement surface with each of the elongate nodules oriented at least primarily in an axial direction. The roller can be positioned on the wafer such that the row of elongate nodules are positioned having the edge of the wafer engage only the outer wafer engagement surfaces of the elongate nodules and not the side surfaces. In some embodiments, the row of nodules can each be positioned helically on the foam roller. During the cleaning process, fluid can be injected outwardly through the foam roller as the roller is rotating and in engagement with the wafer.

A further embodiment of the present invention includes a cylindrical foam roller for post CMP cleaning of wafers having an axis and a cylindrical outer base surface with a matrixical arrangement of nodules extending from the cylindrical outer surface. The nodules can all extend out a uniform distance from the axis circumferentially around the cylindrical foam roller, with each of the elongate nodules oriented with an elongate dimension extending more in an axial direction than a circumferential direction. In one embodiment, each of the nodules is an elongate nodule.

In some embodiments, each of the elongate nodules has a wafer engagement surface, the wafer engagement surface having a outer perimeter with a racetrack shape. In some embodiments, the matrixical arrangement of nodules includes a multiplicity of cylindrical nodules extending radially outward from the outer cylindrical surface of the foam roller. In some embodiments, the matrixical arrangement includes a circumferentially extending row of cylindrical nodules adjacent to the circumferentially extending elongate nodules, the row of cylindrical nodules interlaced with the row of elongate nodules. Each of the nodules of the matrixical arrangement of nodules can have an outer wafer engagement surface, each of said surfaces being parallel to the cylindrical outer base surface of the foam roller. Each of the nodules of the matrixical arrangement of nodules can have an outer wafer engagement surface and a side surface, each of said surfaces being substantially planar.

A feature and advantage of embodiments of the invention is that utilizing elongate nodules to engage the wafers at the top surface of the elongate nodules prevents shear forces and engagement of the wafer corner, between the outer surface and planar faces of the wafer, with the sides of the nodules, minimizing damage to the nodules and maximizing the cleaning action of the roller.

A feature and advantage of embodiments of the invention is that utilizing helically oriented elongate nodules to engage the wafers at the top surface of the elongate nodules provides further minimization of damage to nodules in that the abruptness of the wafer corner(or edge) contact with the nodules may be further reduced as compared to elongate nodules arranged axially (lengthwise) on the roller or compared to nodules with a circular wafer contact surface.

A feature and advantage of embodiments of the invention is that circumferential rows of elongate nodules are interlaced with circumferential rows of nodules having circular wafer engagement surfaces.

A feature and advantage of embodiments of the invention is that a roller may be comprised entirely of elongate nodules arranged in a matrixical arrangement on the outer cylindrical surface of a foam post CMP cleaning roller. The nodules may be arranged parallel to one another. The nodules may be helically arranged. The nodules may be different sizes, including extending radially outward different distances from the cylindrical base surface. The elongate nodules do not need to be uniformly oriented, that is some may be oriented axially (lengthwise) and some may be circumferential or an intermediate orientation (such as helical).

### BRIEF DESCRIPTION

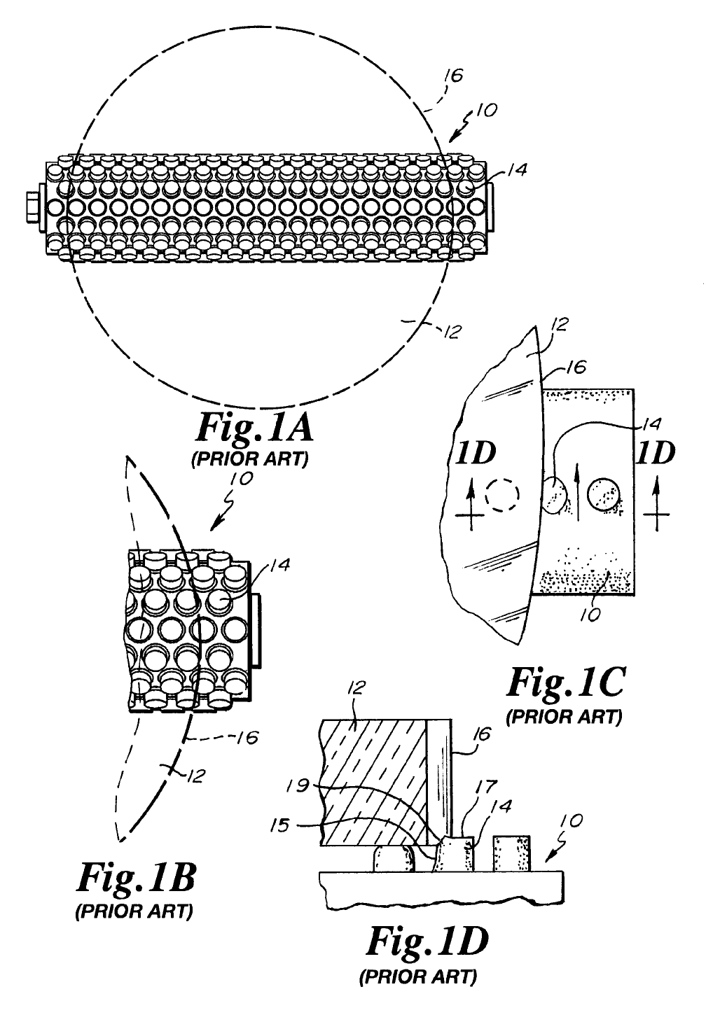

FIG. 1A is an illustration of a prior art post-CMP cleaning brush and a substrate (dashed circle);

FIG. 1B is a partial view of an edge portion of the brush and the substrate of FIG. 1A;

FIG. 1C is a partial view of an edge portion of the brush and the substrate of FIG. 1A;

FIG. 1D is a partial view of an edge portion of the brush and the substrate of FIG. 1A;

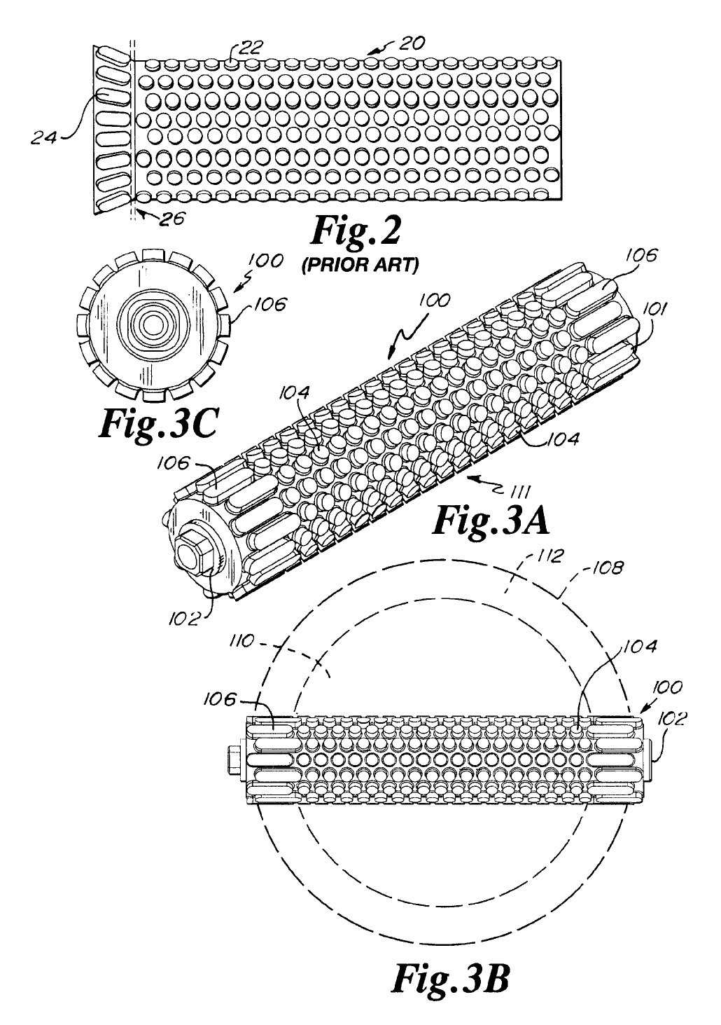

FIG. 2 is another post-CMP cleaning brush from the prior art;

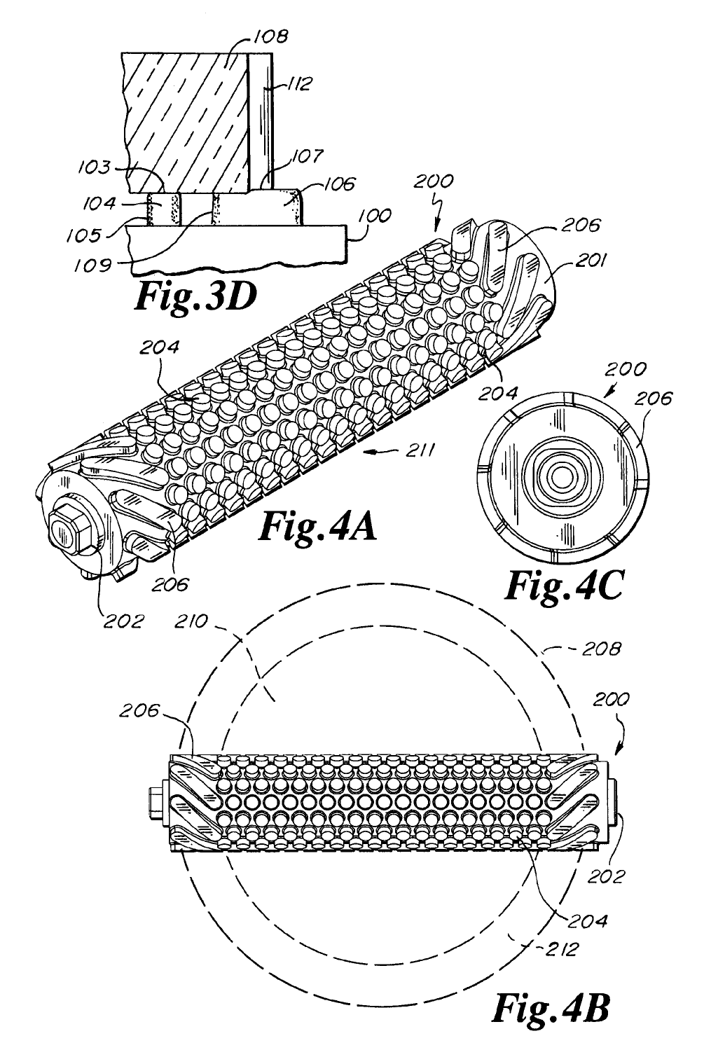

FIG. 3A illustrates a perspective view of a post-CMP cleaning brush according to an embodiment of the present invention on a brush core;

FIG. 3B illustrates a side view of the post-CMP cleaning brush of FIG. 3A cleaning a substrate;

FIG. 3C illustrates an end view of the post-CMP cleaning brush of FIG. 3A;

FIG. 3D is a partial view of an edge portion of the brush and the substrate of FIG. 3A;

FIG. 4A illustrates a perspective view of a post-CMP cleaning brush according to an embodiment of the present invention on a brush core;

FIG. 4B illustrates a side view of the post-CMP cleaning brush of FIG. 4A cleaning a substrate;

FIG. 4C illustrates an end view of the post-CMP cleaning brush of FIG. 4A;

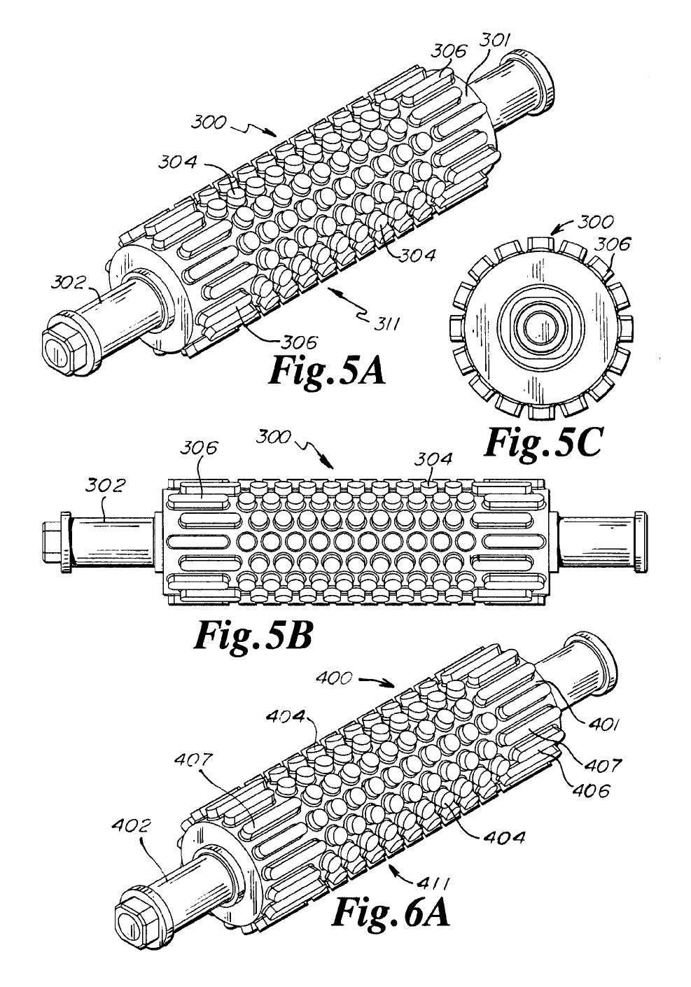

FIG. 5A illustrates a perspective view of a post-CMP cleaning brush according to an embodiment of the present invention on a brush core;

FIG. 5B illustrates a side view of the post-CMP cleaning brush of FIG. 5A cleaning a substrate;

FIG. 5C illustrates an end view of the post-CMP cleaning brush of FIG. 5A;

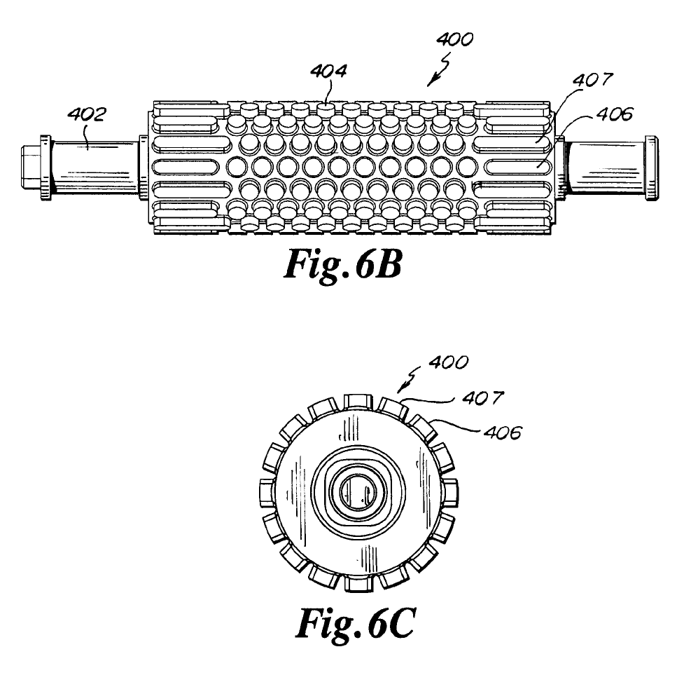

FIG. 6A illustrates a perspective view of a post-CMP cleaning brush according to an embodiment of the present invention on a brush core;

FIG. 6B illustrates a side view of the post-CMP cleaning brush of FIG. 6A cleaning a substrate;

FIG. 6C illustrates an end view of the post-CMP cleaning brush of FIG. 6A;

### DETAILED DESCRIPTION

While various compositions and methods are described, it is to be understood that this invention is not limited to the particular compositions, designs, methodologies or protocols described, as these may vary. It is also to be understood that the terminology used in the description is for the purpose of describing the particular versions or embodiments only, and is not intended to limit the scope of the present invention which will be limited only by the appended claims. The term protrusion and the term nodule can be used interchangeably to describe features of the post-CMP cleaning brushes described herein as would be known to one skilled in the art.

FIGS. 1A-1D depict a prior art post-CMP cleaning brush 10 that can be referred to as a standard brush. Brush 10 includes identical cleaning nodules 14 along the entire length of brush, so that both a central portion of a substrate 12 and an edge portion of the substrate 12 are cleaned with nodules of the same shape. As can be seen in FIGS. 1B, 1C and 1D, in use such brushes 10 can lead to only a portion of nodules 14 contacting the outer edge 16 of the substrate 12. Referring to FIG. 1D, the substrate 12 contacts a corner 19 of a nodule 14 where a side surface 15 and a top or outer surface 17 of the nodule 14 meet. Such partial edge contact between nodules and the wafer edge 16 can cause nodules 14 to deform or break during use and can result in incomplete or non-uniform cleaning of the substrate's end regions as well as damage to the substrate.

Another prior art post-CMP cleaning brush 20 is depicted in FIG. 2. Brush 20 includes standard center nodules 22 having a circular shape as well as edge nodules 24 that include a contour or profile that corresponds to the edge of a substrate wafer to be cleaned. The top surface of the edge nodules 24 is angled or raised relative to the top surface of the center nodules 22. However, there is a circumferentially extending straight line annular or circumferential channel 26 between the edge and center nodules. This can also result in uneven cleaning of a region, such as the edge region, of the substrate.

Cleaning the edge region of substrates, for example removing slurry particles from the edge region of a semiconductor wafer, with post chemical-mechanical planarization cleaning brushes (CMP brushes) such that the cleanliness at a center region of the substrate compared to the cleanliness in the edge region of the substrate (cleanliness may be measured for example by particle counts or light point defects on the substrate, or sessile drop contact angle) is improved compared to traditional CMP brushes and can be achieved by providing a CMP brush that has a combination of central nodules at an inner region of the brush and edge nodules in the near end region of the brush where the central nodules and edge nodules are in a staggered (or matching) arrangement with each other and an upper surface of each edge nodule on the brush has the same or a greater contact area than an upper surface of a central nodule. The area of contact of the upper surface of each edge nodule with the substrate edge region is the same or greater than the area of contact of the upper surface of a central nodule with the substrate center region. Post-CMP cleaning brush can be a foam brush. Fluid can be injected between outwardly through the foam roller brush as the roller is rotating and in engagement with the wafer during the cleaning process.

FIGS. 3A-3C depict a generally cylindrical post-CMP cleaning brush or foam roller 100 according to an embodiment of the present invention. Brush 100 is shown mounted on a brush core or mandrel 102 for rotating the brush, and includes a generally cylindrical body portion 101 having matrixical arrangement 101 of central nodules or protrusions 104 and axial edge nodules or protrusions 106 projecting therefrom. As can be seen in the figure, the brush 100 contacts a substrate 108 such that the center nodules 104 contact a center region 100 of the substrate 108 and the edge nodules 106 contact an edge region 112 of the substrate 108. Center nodules 104 are separated from each other along the length of the brush by gaps and gaps also separate center nodules 104 and edge nodules 106. The approximate edge nodule 106 area that contacts the substrate edge region 112 is greater than the contact area of a center nodule 104 with the center region 108 and all of the edge region is contacted by all or a portion of the axial edge nodules 106. The edge nodules 106 can be provided in a staggered arrangement such that some edge nodules 106 extend to the edge or near the edge of the brush 100 while other edge nodules 106 are offset from the edge of the brush 100. Due to the offsetting, staggered relationship of both types of nodules 104, 106, no annular channel is formed around the brush 100. The edge 106 and central nodules 104 are shown having about the same height and the spacing between central nodules 104 and edge nodules 106 is substantially the same. The large nodule foot print at the outer edge of the post-CMP cleaning brush 100 provides increased cleaning of the substrate edge portion and increased friction or torque with the substrate compared to a brush having only central or standard nodules as illustrated in FIG. 1.

In addition, as can be seen in FIG. 3D, the elongate edge nodules 106 provide for complete contact between the substrate edge and the top or outer wafer engagement surface 107 of the edge nodules 106 as well as the top or outer wafer engagement surface 103 of the central nodules 104. There is therefore no contact between the substrate 108 and the side surface 109 of the edge nodules 106 or the side surfaces 105 of the central nodules 104. This prevents the problems of nodule and substrate damage that can occur with standard brushes due to partial edge contact with nodules on the wafer edge. Although not depicted in detail, it should be noted that all of the edge nodules and central nodules according to embodiments of the present invention described herein include nodules with such side and top or outer wafer engaging surfaces and that in each embodiment the substrate contacts only the outer wafer engagement surfaces of the nodules and not the side surfaces.

Referring now to FIGS. 4A-4C, a post-CMP cleaning brush or foam roller 200 according to another embodiment of the present invention is depicted mounted on a brush core or mandrel 202. Brush 200 includes a generally cylindrical body portion 201 with a matrixical arrangement 201 of a plurality of central nodules 204 and a plurality of spiral or helical edge nodules 206 for cleaning a substrate 208 projecting therefrom. In one embodiment, edge nodules 206 occupy a distance from the brush edge towards the center of the brush that is between two and four central nodules 204 in length (including gaps). For example, in the depicted embodiment the edge nodules 206 have a length extending approximately three central nodules 204 inwardly from the edge of the brush 200. The configuration of edge nodules 206 is generally helically or spirally shaped in this embodiment. These edge nodules 206 provide an area of contact underneath/inside the outer substrate edge 211 on an edge region 212 of the substrate 208 that is greater than the contact area of a central nodule 204 with the center region 210 of the substrate. The spiral edge nodules 206 are arranged in a staggered alignment with the central nodules 204 such that no annular or circumferential channel is formed between the central 204 and edge 206 nodules.

FIGS. 5A-5C depict a post-CMP cleaning brush or foam roller 300 according to another embodiment of the present invention shown mounted on a brush core or mandrel 302 for rotating brush 300. Brush 300 includes a generally cylindrical body 301 with a matrixical arrangement 311 of central nodules 304 and axial edge nodules 306 protruding therefrom. The edge nodules 306 are each equal in area and length and are providing in a staggered arrangement such that some nodules extend to near the edge of the brush while some are offset and overlap with the central nodules 304. The length (long dimension) of the top surface of an edge nodule 306 can be less than the length encompassed by four central nodules 304 (including gaps). In addition, the width, or shorter dimension, of the top surface of an edge nodule 306 can less than the diameter of a central nodule 304 in this embodiment. The total area encompassed by the top surface of an edge nodule 306 can be less than the total area encompassed (including gaps) by three central nodules 304. A portion of an edge nodule that contacts the substrate and a portion of the edge nodule that does not contact the substrate are both at least as large as a central nodule. The area of the edge nodules is selected in order to provide a uniform distribution of a frictional force between a substrate and the brush 300 and to minimize substrate vibration, which results in uniform cleaning between center and edge regions of the substrate. An overlap between the central nodules 304 and edge nodules 306 is provided so that no straight and continuous annular or circumferential channel extending around the brush 300 is formed. The larger nodule footprint provided at the outer edge provides increased cleaning of the wafer edge. The post-CMP cleaning brush 300 in these figures has about the same, within ±10%, or less of the friction/torque with the substrate as compared to a brush with only the same sized central protrusions as illustrated in FIG. 1.

Referring now to FIG. 6A-6C, another embodiment of a post-CMP cleaning brush or foam roller 400 according to the present invention shown mounted on a brush core or mandrel 402 for rotating brush 400 is depicted. Brush 400 includes a generally cylindrical body portion 401 with a matrixical arrangement 411 of central nodules 404 and first axial edge nodules 406 having a first length and second axial edge nodules 407 having a second length projecting therefrom. First 406 and second 407 edge nodules both extend to near the edge of the brush 400, however the greater length of second edge nodules 407 provides an offset between the edge nodules 406, 407 as well as an overlap with central nodules 404, which provides no circumferential or axial channel. The length of the first edge nodules 406 can be less than the length of three central nodules 404 (including gaps) and the length of the second edge nodules 407 can be less than the length encompassed by four central nodules 404. In addition, the width of each edge nodule 406, 407 can be less than the diameter of a central nodule. A portion of each edge nodule 406, 407 that contacts the substrate edge portion and portion that does not contact the substrate can both be at least a large as a central nodule 404. The area of the edge nodules is chosen such that frictional force between the substrate and cleaning brush has a uniform distribution across the substrate and substrate vibration is minimized such that cleaning at the center and edges of the substrate are similar. The larger nodule footprint at the outer edge of the brush provides increased cleaning of wafer edge and provides about the same friction/torque, within about ±10%, or less, with substrate as compared to the friction or torque measured with a standard brush that has only the central nodules.

Central nodules have a top surface and a height which can be measured from a rotational axis of the brush to the top surface. The edge nodules similarly have a top surface and a height which can be measured from the rotational axis of the brush to the top surface. In some embodiments, central nodule top surface height and the edge nodule top surface height are the same (about ±1%, or less) or differ by an amount less than an edge profile portion of the substrate.

In some embodiments of the present invention, the area of a top surface of an edge nodule is greater than the area of a top surface of a central nodule and the area of a top surface of an edge nodule is less than the area encompassed by four central nodules. In some embodiments, the area of a top surface of an edge nodule is less than the area encompassed by three central nodules. In other embodiments, the brush can have a combination of edge nodules with different areas. For example, as shown in FIGS. 6A-6C, some edge nodules can have a top surface area that is less than the area encompassed by four or fewer central protrusions and other protrusions have a top surface area that is less than the area encompassed by three or fewer central protrusions.

Various embodiments of the present invention include a combination of central nodules at the inner region of the brush and edge nodules at one or more end regions of the brush in a staggered configuration with the central nodules. This provides a variation in nodule profile across the brush which can be used to create a variation in contact pressure, friction, as well as contact area by the nodules from the substrate center region to the substrate edge regions. This also precludes formation of a circumferential channel. Axial channels may be formed between rows of nodules.

Generally, the contact area of an edge nodule is larger than the area of a central nodule that contacts a substrate. The area of contact of the edge nodules of one row partially overlap an area of contact of the central nodules of adjacent rows so that full contact coverage by the nodules on the substrate results during CMP brush cleaning. In some versions the edge nodules extend near the end of the first end and second end of the brush as illustrated in FIGS. 6A-6C. In other versions the edge nodules can be offset from the ends of the brush as shown in FIGS. 5A-5C.

The central region of the brush can generally contact from 30% to 90% of the substrate surface area in the central part of the substrate. In some embodiments, the central region of the brush can contact from 55% to 65% of the substrate surface area in the central region of the substrate. More particularly, the central region of the brush can contact from 57% to 62% of the substrate surface area in the central region of the substrate.

The central nodules at an inner region of the brush can be nodules that include planar circular nodules, elongated 2- or 3-dimensional nodules, frusto-conical nodules, truncated cones, nodules having circular, ellipsoidal, rectangular, triangular, rounded rectangle, trapezoid, or diamond shaped cross sections, and other readily moldable shapes known in the art. In some embodiments, the nodules can have one or more rounded or radius corners, and combinations of any of these. Each central nodule has an upper surface that has an area of contact with a substrate that is the same or less than the area of contact of the upper surface of each edge nodule with the substrate.

Edge nodules in the near end region(s) of the brush can be nodules that include planar circular nodules, elongated 2- or 3-dimensional nodules, frusto-conical nodules, truncated cones, nodules having circular, ellipsoidal, rectangular, triangular, rounded rectangle, trapezoid, or diamond shaped cross sections, and other readily moldable shapes known in the art. In some embodiments the nodules can have one or more rounded or radius corners, and combinations of any of these. In some embodiments the edge nodules have an end radius that corresponds to the central region nodules of the brush. In other embodiments, the end radius is larger or smaller than the radius of the central nodules. Edge nodules provide an area of contact “underneath” or inside the substrate edge and the edge nodules can have available contact area that extends out from “underneath” the substrate edge.

The area of contact of the upper surface of each edge nodule with the substrate is generally the same or greater than the area of contact of the upper surface of a central nodule with the substrate. In some embodiments of the post-CMP cleaning brush, such as illustrated in FIGS. 6A-6C, the edge nodules have a first length and a second length, where the first length is different from the second length. The top surface of some edge nodules can also have a first area and others have a second are with the first area different from the second area. In other embodiments, all of the edge nodules can have the same length and area or there could be edge nodules with three or more different lengths or top surface areas.

The one or more of the edge nodules on the brush substantially provide at least the area of a central nodule in contact with the substrate. In some versions of the invention all or a portion of one or more edge nodules can extend to the end or near the end of the brush. In some versions of the invention the edge nodules may be parallel from a line extending through a row of central nodules, these nodules are termed “axial” edge nodules. In other versions of the invention, all or a portion of one or more edge nodules can originate along a line extending/extrapolated through one row of central nodules and the edge nodule may extend in a non-parallel direction across lines extending/extrapolated through one or more rows of adjacent central nodules; in some versions these are termed spiral edge nodules or helical edge nodules. In some versions where the edge nodules extend in a non-parallel direction across one or more rows of adjacent central nodules, the outer most portion of the edge nodules may or may not end in line with one of the adjacent rows of central nodules. Edge nodules lack a profile that corresponds to the edge of a substrate that the brushes contact.

In some embodiments of the invention, the top surface area of the edge nodules is greater than the area of a single central nodule and the length, width, and area of the top surface of the edge nodules is about the same as the area covered by three central nodules (including gaps), as illustrated in FIGS. 3A-3C and in FIGS. 4A-4C. In other embodiments of the invention, the top surface area of the edge nodules is greater than the area of a single central nodule but is less than the area encompassed by four central nodules (including gaps) and in some cases is less than the area encompassed by three central nodules (including gaps). In some embodiments, there are no partial nodules on the edge of the brush.

Nodules on the brush provide full contact coverage of the substrate—nodules are positioned and sized so that the entire substrate surface is contacted with one or more nodules on the surface of the rotating brush during cleaning. For example, in one embodiment of the invention central nodules may be spaced substantially equally in a row that extends parallel to the axis of rotation of the brush with the nodules or nodule in a single row are separated from each other by a gap. The central nodules in adjacent rows can then be staggered one row to the next to provide full contact coverage of the substrate surface. In some embodiments, the area of the top of one row of nodules overlaps the gaps between spaced nodules in adjacent rows. No annular channels are formed by any nodules on brush and especially where edge nodules are positioned.

Edge nodules are located at the ends of each row of central nodules and are spaced apart from the central nodules by a gap that is similar or the same as the gap between the central nodules. The length of the edge nodules can extend to the edge or near the edge of the brush or they may be offset from the edge of the brush.

Brushes in versions of the invention may be molded to form a cylindrical body having an outer surface and a plurality of central nodules extending from the outer surface. Central nodules can be disposed at regular intervals in parallel or slanted rows. The spaces between the rows can define channel that can be axial, slanted or at varying angles to the axis of rotation of the brush. The central nodules may be offset from one another, in a direction along the longitudinal axis of the cylindrical body, and have a size that results in a staggered and overlapping arrangement of nodules in the parallel rows thereby providing complete contact coverage of the substrate surface by one or more nodules. An offset of the central nodules can form spiral channels along the outside of the brush formed by pairs of central nodules in adjacent rows.

In versions of the invention the staggered combination of central region nodules and edge region nodules provides substantially the same contact pressure or friction and enhanced contact-time between the edge nodules and the substrate edge region, as measured by particle counts or particle adders on the substrate surface, insufficient brush compression or lack of brush twist, contact pressure or friction between the central nodules and the inner region of the substrate, or any combination of these. In versions of the post CMP brush with edge nodules and central nodules, the brush can be characterized in that the friction or torque measured between the brush and a substrate is within about ±10% or is less than the friction or torque measured between the same substrate and a brush that only has the central nodules covering the central and edge regions as illustrated by the standard brush shown in FIG. 1.

The brushes of the present invention may be made to slip onto brush cores or mandrels or may be cast onto cores. The brushes can be made using a suitable material that is firm, porous, elastic, and has certain abrasion resistiveness. In some versions of the invention, the main raw starting material for the device is polyvinyl alcohol. Polyvinyl alcohol is used to form a polyvinyl acetal porous elastic material. The porous material varies in characteristic depending upon cleanliness, type of pore forming agent or process, type of aldehyde employed for the conversion of a polyvinyl alcohol to a polyvinyl acetal, and other factors. The PVA sponge material may be prepared from an acid catalyst and an aldehyde mixed with a water solution of polyvinyl alcohol produced from polyvinyl acetate homopolymer or polyvinyl acetate containing copolymers less than 25% by weight or alloyed with water soluble polymers to no greater than 10% by weight of solids. Other factors which affect the properties of the porous material also include the relative proportions of reactants, catalysts, reaction temperature and time, and the general condition and starting materials in the manufacturing process. Cleanliness of the manufacturing process is also important in the manufacturing of these devices. Other moldable brush materials such as but not limited to nylon, polyurethane, or a combination of polyurethane and PVA or other copolymers that do not scratch substrate surfaces and provide suitable material removal for the process may be used including U.S. Pat. No. 4,083,906 Schindler (polyethylene glycol-polyacrylamide); U.S. Pat. No. 5,311,634 Andros, Nicholas (surfactant air foam systems and core cast); U. S. Pat. No. 5,554, 659 Rosenblatt, Solomon (Surfactant air foam); U.S. Pat. No. 2,609,347 Wilson, Christopher (Early surfactant foam systems); and U.S. Pat. No. 3,663,470 Nishimura et al (Early starch based sponges), the contents of which are incorporated herein by reference. Brushes and methods of making are also described in WO/2005/016599, the contents of which are incorporated herein by reference.

The substrate can be semiconductor wafers, compact discs, glass substrates and the like. These substrates can be cleaned with the post CMP cleaning brushes of the present invention using a conventional PVA brush scrubber. The conventional scrubber comprises a pair of PVA brushes and each brush comprises a plurality of raised nodules across the surface thereof, and a plurality of valleys located in-between the nodules. The scrubber also comprises a platform for supporting a wafer and a mechanism for rotating the pair of PVA brushes. The platform comprises a plurality of spinning mechanisms for spinning the wafer or other suitable substrate to be cleaned. General aspects of operation of brush box operation are disclosed in U.S. Pat. No. 6,299,698 and U.S. Pat. No. 5,675,856, which are herby incorporated by reference.

The central and edge regions of the brush have a plurality of nodules that contact the wafer during polishing. A set of central nodules is located on the central portion of the brush. The nodules can define a planar or cylindrical contact surface. The planar or cylindrical contact surface of the nodules can be circular or symmetric for ease of manufacture. Rows of circular planar nodules can be formed. Similarly a set of edge nodules is located on the edge portion of the brush. The edge nodules contact the edge region of the substrate. In one embodiment, edge nodules are rectangular with radiused corners. The edge nodules are not damage by the cleaning process.

A recessed area, sometimes referred to as gaps, surrounds both the central and edge nodules so as to provide a channel through which post-CMP cleaning chemistries, solvents, and slurry residue (removed from the substrate surface) and other contaminants may travel. In this manner, slurry residue is effectively cleaned from both the wafer's planar surfaces and from the wafer's edge surfaces by the central and edge nodules. Solvents and slurry residue may easily travel through the recessed area and gaps until gravity and/or an auxiliary liquid flow removes the slurry residue or other particulate contaminants from each brush.

While several exemplary articles, compositions, apparatus, method embodying aspects of the present invention have been shown, it will be understood, of course, that the invention is not limited to these embodiments. Modification may be made by those skilled in the art, particularly in light of the foregoing teachings. For example, components and features of one embodiment may be substituted for corresponding components and features of another embodiment. Further, the invention may include various aspects of these embodiments in any combination or sub-combination.

1. A brush for cleaning of substrates following chemical mechanical polishing (post-CMP) of the substrates comprising:
a generally cylindrical body;
a plurality of central nodules projecting outwardly from the cylindrical body in a central region of the body, the central nodules being spaced apart from each other and separated by central gaps;
a plurality of edge nodules projecting outwardly from the cylindrical body and having a different shape than the central nodules, a first set of edge nodules disposed between the central region and a first end of the body and a second set of edge nodules disposed between the central region and a second end of the body, the central nodules being spaced apart from each set of edge nodules by edge gaps; and wherein:
adjacent circumferential columns of edge nodules and central nodules are provided in a staggered, interlaced alignment around the body such that the edge gaps between the edge nodules and central nodules do not form a straight annular channel extending circumferentially around the body;
a top surface of each edge nodule has a greater surface area adapted to contact a substrate than a surface area of a top surface of each central nodule; and
the top surfaces of the edge nodules and the top surface of the central nodules extend substantially a same height from the body.

2. The post-CMP brush of claim 1, wherein the first set of edge nodules and the second set of edge nodules are each a single circumferential column of edge nodules.

3. The post-CMP brush of claim 1, wherein the surface area of the top surface of each edge nodule is less than the area encompassed by the top surface of four central protrusions and associated center gaps.

4. The post-CMP brush of claim 3, wherein the surface area of the top surface of each edge nodule is substantially equal to the area encompassed by the top surface of three central protrusions and associated center gaps.

5. The post-CMP brush of claim 1, wherein the edge nodules and central nodules are arranged in axial rows defining axial channels between the rows.

6. The post-CMP brush of claim 1, wherein the edge nodules in at least one of the first and second set of edge nodules include edge nodules having a first length and edge nodules having a second length greater than the first length.

7. The post-CMP brush of claim 6, wherein the edge nodules having the first length and the edge nodules having the second length alternate circumferentially around the body and are aligned adjacent an edge of the body such that the edge nodules having the second length extend farther towards the center region of the body than the edge nodules of the first length.

8. The post-CMP brush of claim 1, wherein the edge nodules in at least one of the first and second set of edge nodules are all of a same length.

9. The post-CMP brush of claim 8, wherein the edge nodules of the same length are disposed circumferentially around the body and alternate being aligned adjacent an edge of the body and being offset further inward on the body.

10. A method of post CMP cleaning of a surface of a semiconductor wafer, the method comprising:
engaging the surface of a rotating wafer with a rotating cylindrical foam roller, the cylindrical foam roller having a circumferentially extending row of elongate nodules extending around the cylindrical foam roller,
each of the nodules having a side surface and an outer wafer engagement surface, each of the elongate nodules oriented at least primarily in an axial direction,
positioning the roller on the wafer such that the row of elongate nodules are positioned having the edge of the wafer engage only the outer wafer engagement surfaces of the elongate nodules and not the side surfaces.

11. The method of claim 10 wherein the row of nodules are each positioned helically on the foam roller.

12. The method of claim 10 further comprising the step of injecting fluid outwardly through the foam roller as the roller is rotating and in engagement with the wafer.

13. A cylindrical foam roller for post CMP cleaning of wafers, the cylindrical foam roller having an axis and a cylindrical outer base surface with a matrixical arrangement of nodules extending from the cylindrical outer surface, at least a plurality of the nodules having an elongate shape, the nodules all extending out a uniform distance from the axis, the nodules extending circumferentially around the cylindrical foam roller, each of the nodules oriented with their elongate dimension extending more in an axial direction than a circumferential direction, and each of the nodules have a top surface area and wherein the nodules are not all of a uniform top surface area.

14. The method of claim 10 further comprising utilizing elongate nodules with a wafer engagement surface, the wafer engagement surface having a outer perimeter with a racetrack shape.

15. The foam roller of claim 13 wherein the matrixical arrangement of nodules includes a multiplicity of cylindrical nodules extending radially outward from the outer cylindrical surface of the foam roller.

16. The method of claim 10 further comprising using the matrixical arrangement that includes a circumferentially extending row of cylindrical nodules adjacent to the circumferentially extending elongate nodules, the row of cylindrical nodules interlaced with the row of elongate nodules.

17. The foam roller of any of claims 13 wherein each of the nodules of the matrixical arrangement of nodules has an outer wafer engagement surface, each of said surfaces being parallel to the cylindrical outer base surface of the foam roller.

18. (canceled)

19. The foam roller of claim 13, wherein each of the nodules is an elongate nodule.
